(19) United States
(12) Patent Application Publication
(10) Pub. No.: US 2013/0001906 A1
(43) Pub. Date: Jan. 3, 2013

(54) MASONS' CART

(75) Inventor: Alex J. Richards, Boise, ID (US)

(73) Assignee: Ken J. Pedersen, Boise, ID (US)

(21) Appl. No.: 13/478,105

(22) Filed: May 22, 2012

Related U.S. Application Data
(63) Continuation-in-part of application No. 29/396,259, filed on Jun. 28, 2011, now Pat. No. D660543.

(51) Int. Cl. B62B 1/00

(52) U.S. Cl. 280/47.31

(57) ABSTRACT

A masons' cart of attractive, durable and economical construction has a generally flat, and relatively low, top platform for receiving, carrying and unloading heavy loads. Also, the cart's top platform has generally low peripheral side edges so that the heavy loads may be more easily lifted up to the height of the low platform, and up and over the low peripheral side edges. The cart is supported on its front end by at least one wheel, and supported on its back end by at least one leg adapted to rest on the ground or floor. At least one long handle extends from the cart's back end for the user to grasp, to near the front end. The front end of the handle is integrated into the top platform and wheel strut near the front of the cart. This way, the cart handle adds rigidity and strength to the masons' cart's frame.

This application is a continuation-in-part of, and claims priority from, my prior, co-pending U.S. design application #29/396,259, filed Jun. 28, 2011, issuing as Pat. No. D660543 on May 22, 2012, and entitled “Garden Cart Top”, the entire disclosure of which is incorporated herein by reference.

### BACKGROUND OF THE DISCLOSED TECHNOLOGY

1. Field of the Disclosed Technology

This disclosed technology relates to carts for carrying and transporting loads, typically masons' carts powered by humans. More specifically, this disclosed technology relates to masons' carts, which are typically configured with low load platforms and low peripheral side edges for loading, carrying, and unloading heavy loads of stones, tiles and bricks, and cement and grout therefor.

2. Related Art

U.S. Pat. #8,070,181 Forrest etal. discloses in its FIG. 10 a low, flat platform cart with low peripheral side edges, the cart being reversibly convertible to this low configuration from an upright, generally cubic utility cart configuration.

### SUMMARY OF THE DISCLOSED TECHNOLOGY

This disclosed technology is a masons' cart of attractive, durable and economical construction. The cart has a generally flat, and relatively low, top platform for receiving, carrying and unloading heavy loads. Also, the cart's top platform has generally low peripheral side edges so that the heavy loads may be more easily lifted up to the height of the low platform, and up and over the low peripheral side edges.

The subject cart is supported on its front end by at least one wheel, and supported on its back end by at least one leg adapted to rest on the ground or floor. At least one long handle extends from the cart's back end for the user to grasp, to near the front end. The front end of the handle is integrated into the cart top platform and a wheel strut for the wheel near the front of the cart. This way, the cart handle adds rigidity and strength to the masons' cart's frame.

### BRIEF DESCRIPTION OF THE DRAWINGS

FIG. 1 is a rear, side perspective view of one embodiment of the subject disclosed technology in its operating orientation.

FIG. 2 is a bottom, side perspective view of the embodiment depicted in FIG. 1, but in its storage orientation.

FIG. 3 is a right side view of the embodiment depicted in FIGS. 1 and 2.

FIG. 4 is a left side view of the embodiment depicted in FIGS. 1-3.

FIG. 5 is a rear view of the embodiment depicted in FIGS. 1-4.

FIG. 6 is a front view of the embodiment depicted in FIGS. 1-5.

FIG. 7 is a top view of the embodiment depicted in FIGS. 1-6.

FIG. 8 is a bottom view of the embodiment depicted in FIGS. 1-7.

FIG. 9 is an exploded view of the embodiment depicted in FIGS. 1-8.

FIG. 10 is a rear, side perspective view of another embodiment of the subject disclosed technology in its operating orientation.

FIG. 11 is a bottom, side perspective view of the embodiment depicted in FIG. 10, but in its storage orientation.

FIG. 12 is a right side view of the embodiment depicted in FIGS. 10 and 11.

FIG. 13 is a left side view of the embodiment depicted in FIGS. 10-12.

FIG. 14 is a rear view of the embodiment depicted in FIGS. 10-13.

FIG. 15 is a front view of the embodiment depicted in FIGS. 10-14.

FIG. 16 is a top view of the embodiment depicted in FIGS. 10-15.

FIG. 17 is a bottom view of the embodiment depicted in FIGS. 10-16.

FIG. 18 is an exploded view of the embodiment depicted in FIGS. 10-17.

FIG. 19 is a rear, side perspective view of yet another embodiment of the subject disclosed technology in its operating orientation.

FIG. 20 is a bottom, side perspective view of the embodiment depicted in FIG. 19, but in its storage orientation.

FIG. 21 is a right side view of the embodiment depicted in FIGS. 19 and 20.

FIG. 22 is a left side view of the embodiment depicted in FIGS. 19-21.

FIG. 23 is a rear view of the embodiment depicted in FIGS. 19-22.

FIG. 24 is a front view of the embodiment depicted in FIGS. 19-23.

FIG. 25 is a top view of the embodiment depicted in FIGS. 19-24.

FIG. 26 is a bottom view of the embodiment depicted in FIGS. 19-25.

FIG. 27 is an exploded view of the embodiment depicted in FIGS. 19-26.

### DETAILED DESCRIPTION OF ONE EMBODIMENT OF THE DISCLOSED TECHNOLOGY

Referring to the Figures, there are shown several, but not the only, embodiments of the disclosed technology.

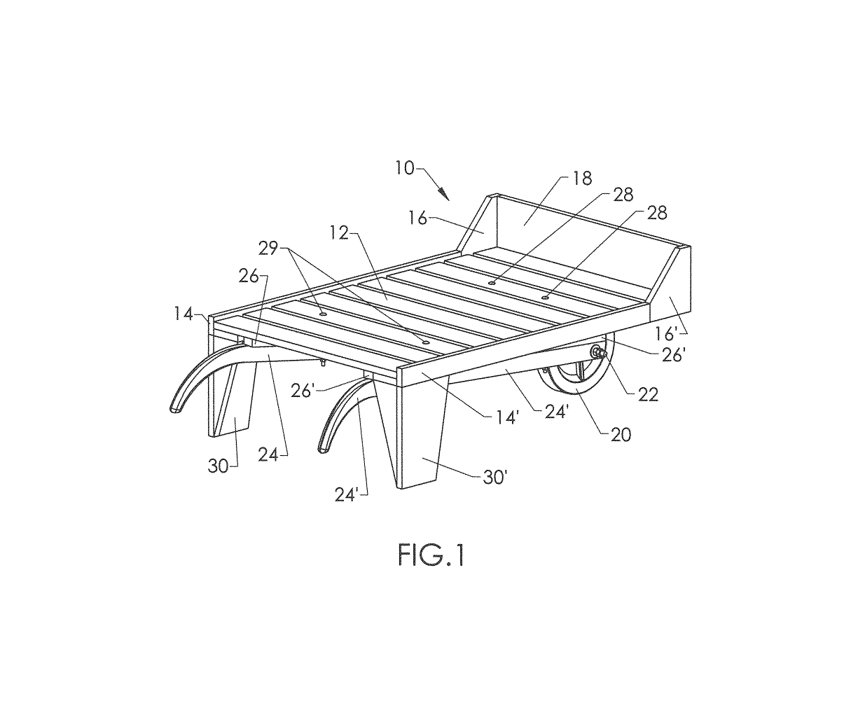

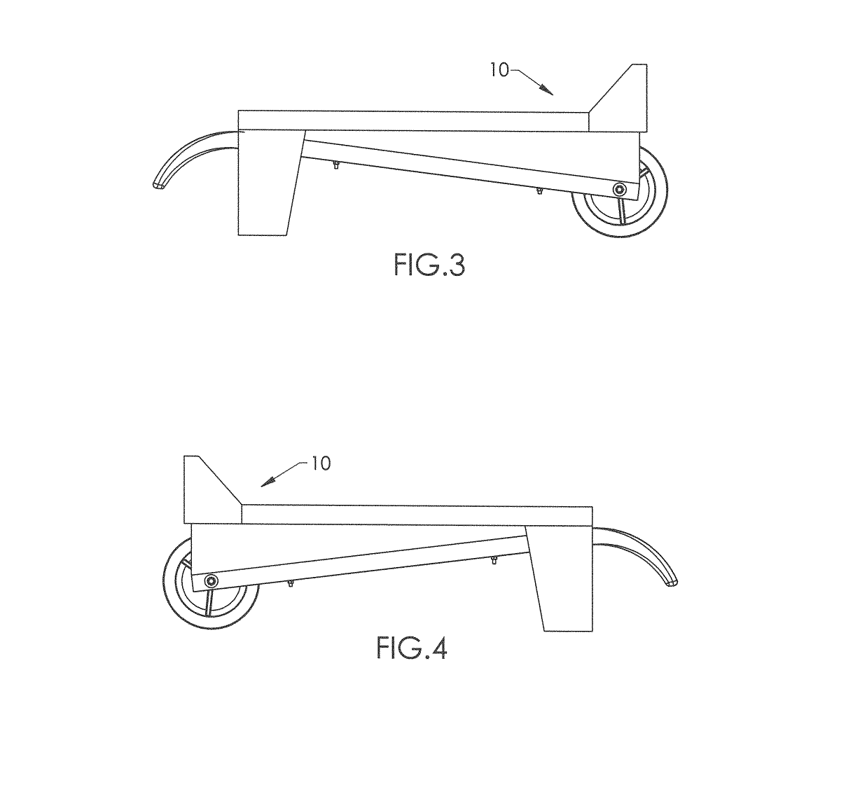

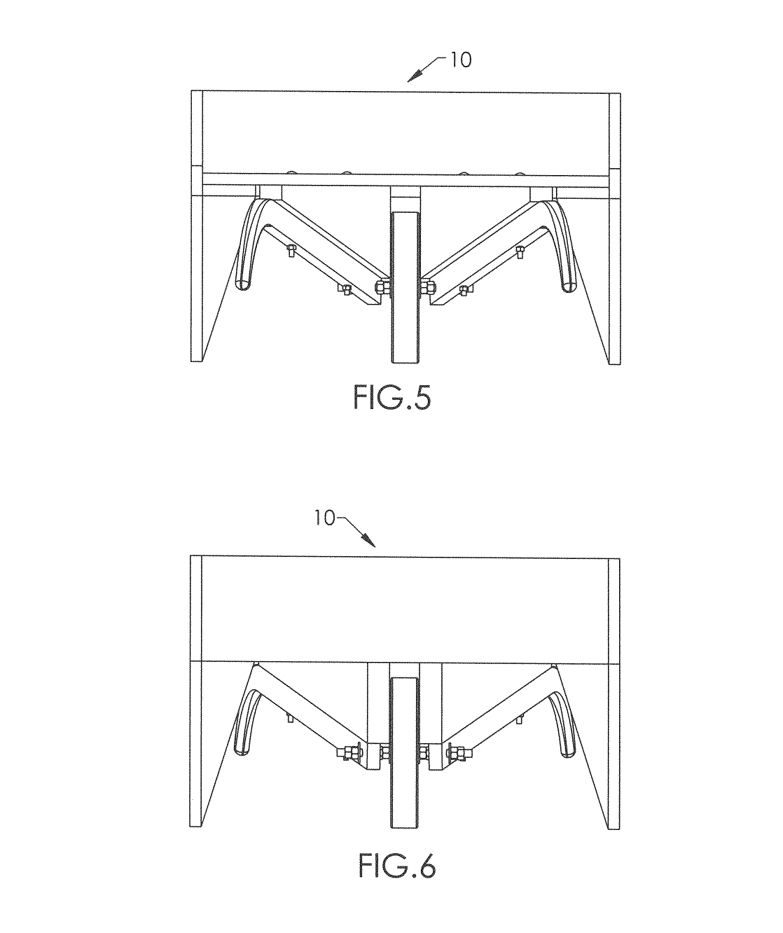

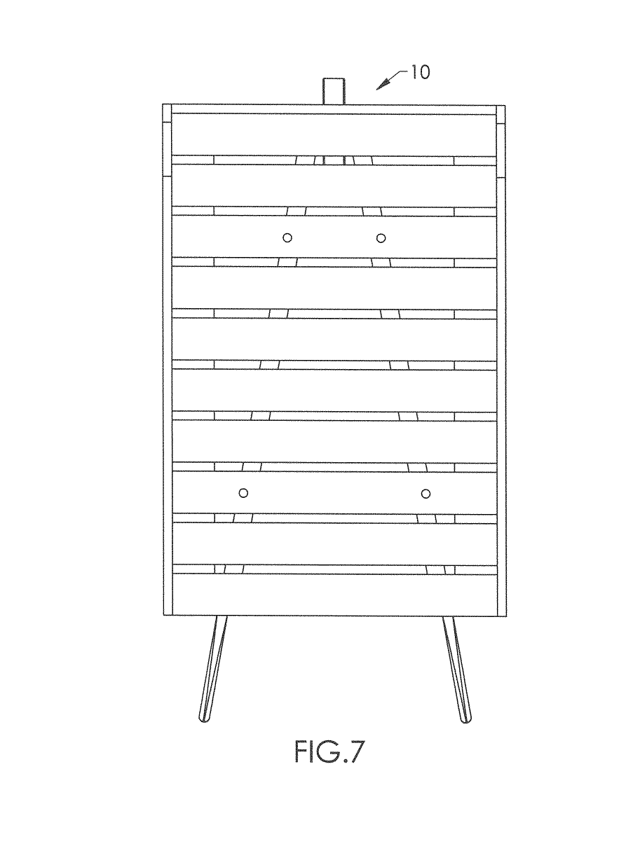

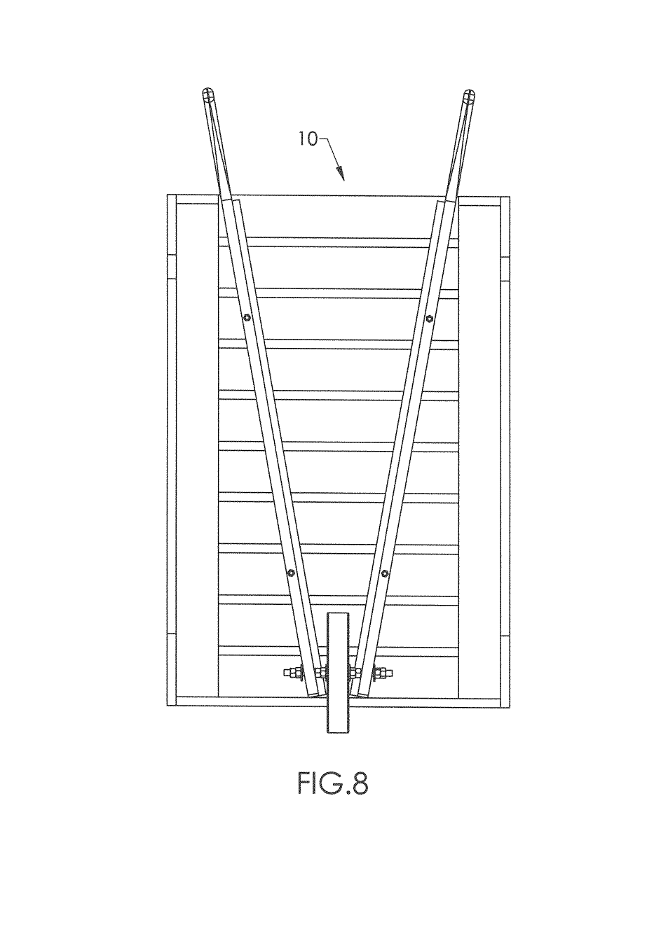

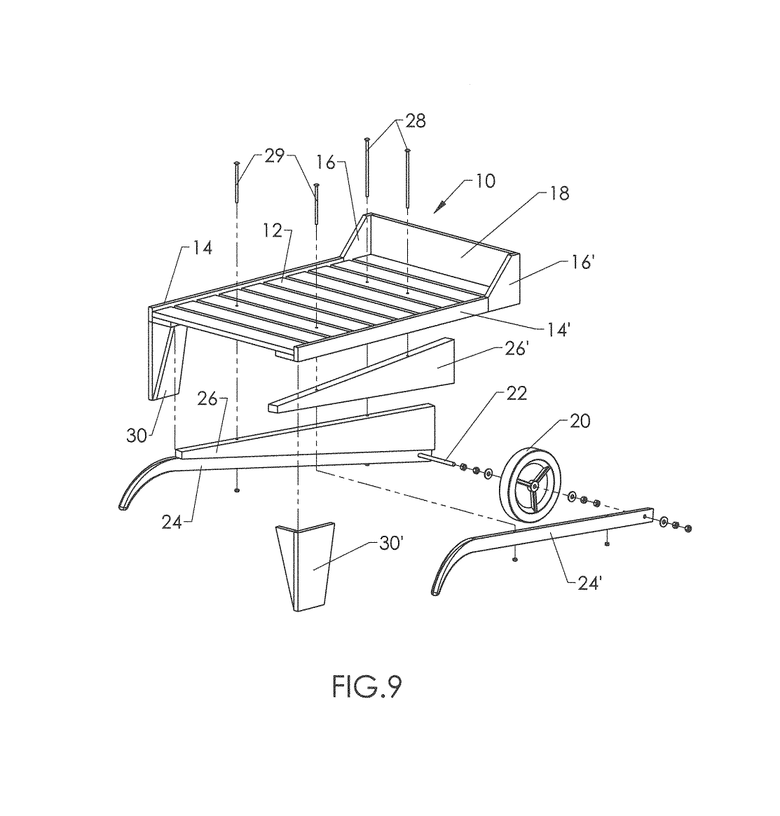

Embodiment 10 of the subject disclosed technology is depicted in FIGS. 1-9. Embodiment 10 has generally flat, and relatively low, top platform 12. Platform 12 is formed by a set of width-wise slats, slightly spaced-apart in the length-wise direction. Upwardly-standing side rails 14 and 14′ form relatively low peripheral side edges of platform 12. Generally, side rails, 14 and 14′ extend up above platform 12 about ½-1½ inches, or in certain embodiments about ½-2½ inches. Platform 12's front end is relatively higher, comprising side buttresses 16 and 16′, and end board 18. End board 18 extends up above platform 12 about 3-6 inches. This way, when platform 12 is loaded, and masons' cart 10 is picked up by the user to move it, the load is not pitched off the front of the cart.

Embodiment 10 has one wheel 20, the wheel 20 being mounted on an axle 22 which passes through the lateral front sides of two, long handles 24 and 24′. Handles 24 and 24′ extend from near the back to near the front of cart 10. Handles 24 and 24′ are secured beneath wheel struts 26 and 26′ (struts 26 and 26′ being barely visible in FIG. 1) by long bolts 28. This way, handles 24 and 24′ are secured to struts 26 and 26′, respectively, and also to platform 12, resulting in a rigid and strong combination thereof.

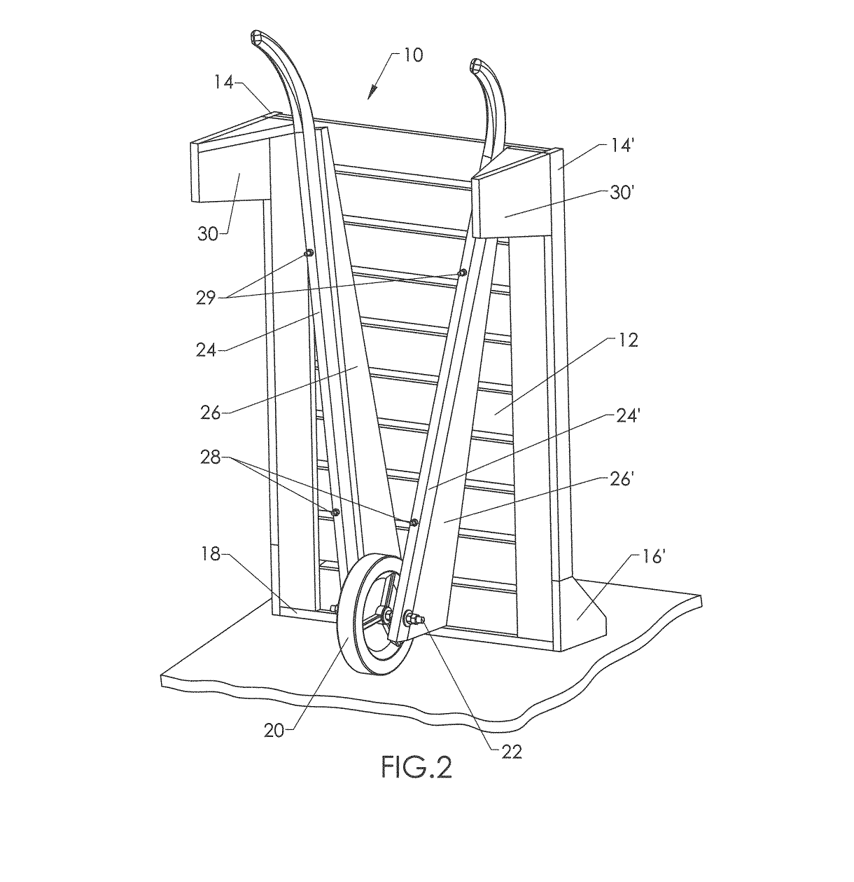

Also, masons' cart 10 has two rear legs 30 and 30′, extending downwardly from the bottom of platform 12, to support the back end of the cart when it is at rest. Synergistically, when constructed as shown, the horizontal plane for the center of gravity of cart 10 is between the bottom of platform 12 and axle 22. The way, when the cart 10 is tipped up all the way to rest on the front surface of end board 18, the cart will conveniently rest in this orientation for storage with less footprint as depicted in FIG. 2.

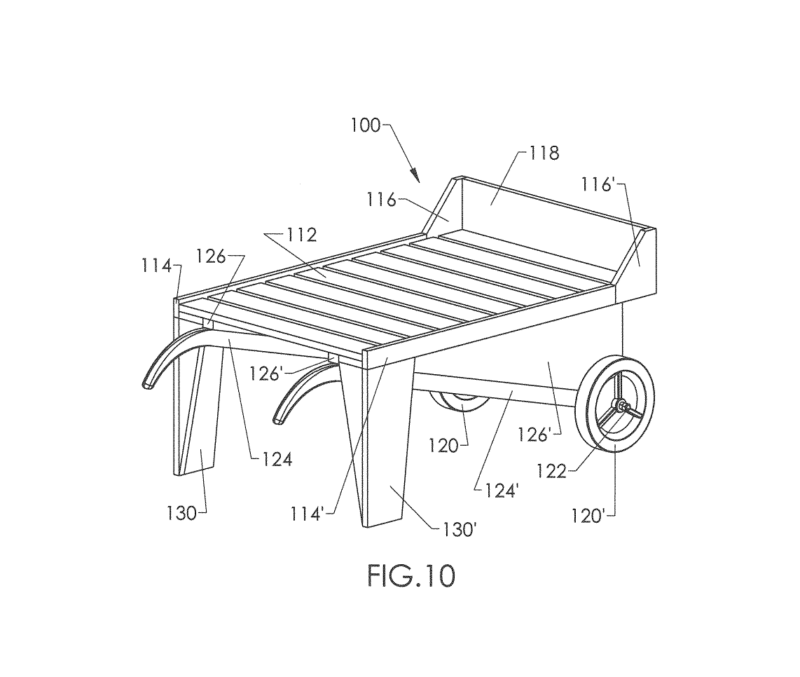

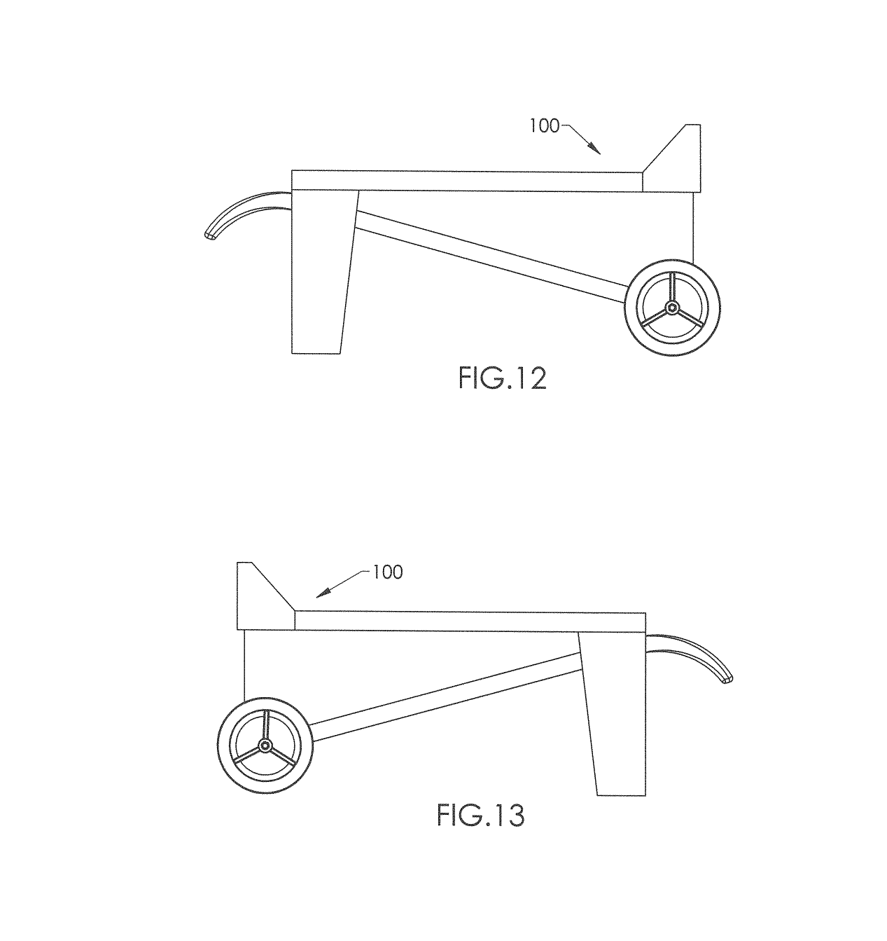

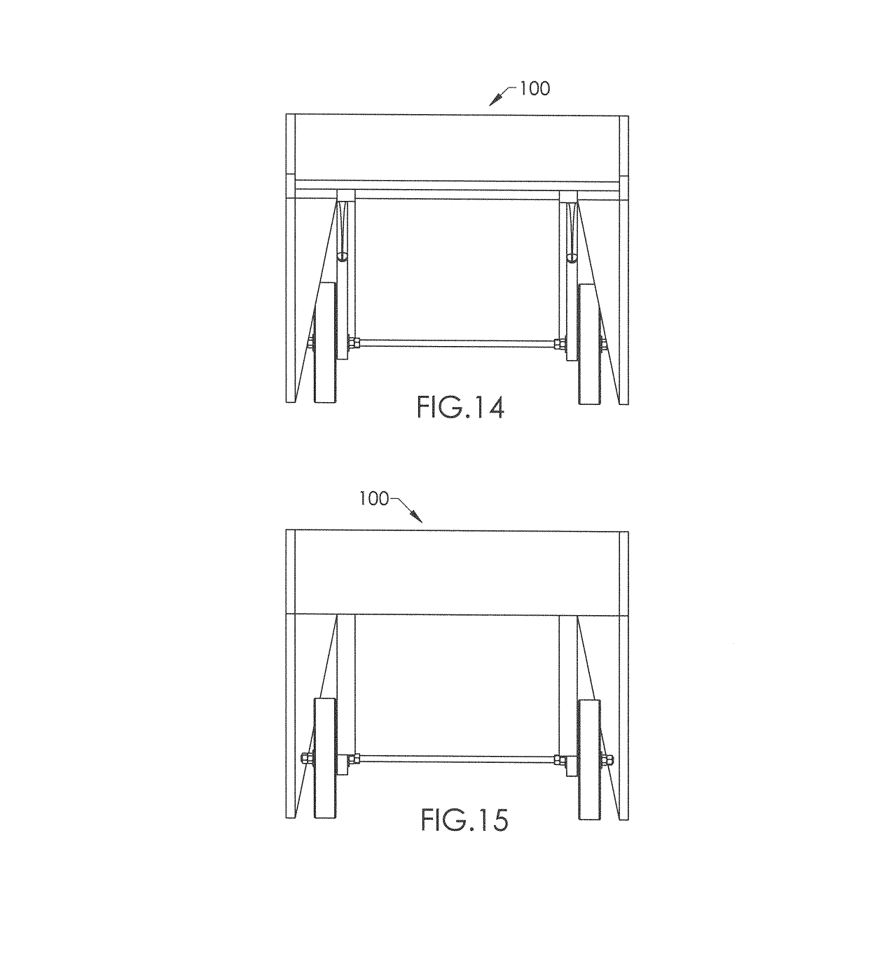

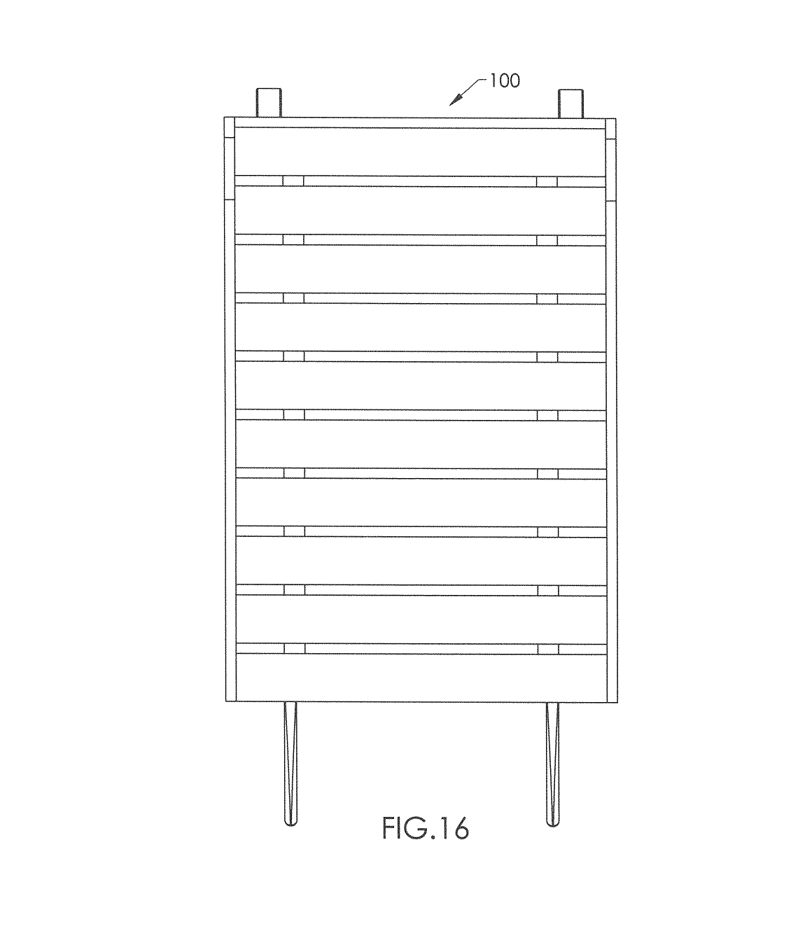

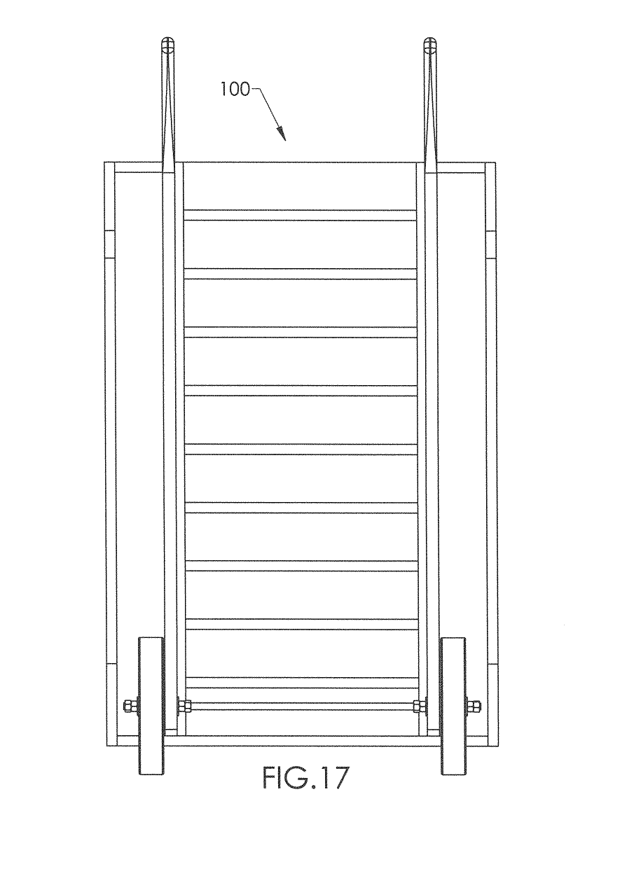

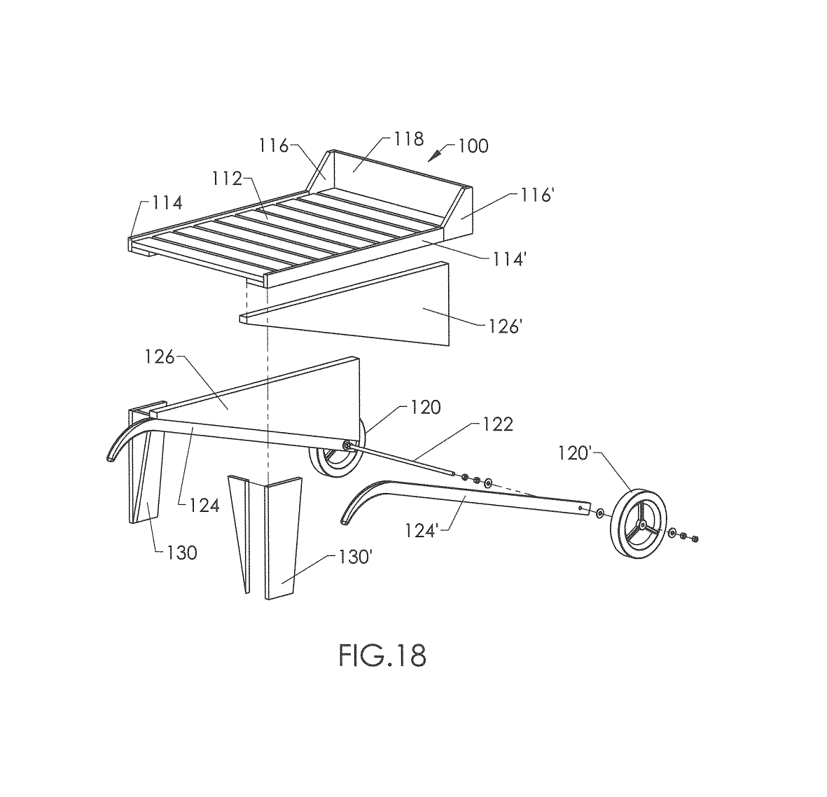

Embodiment 100 of the subject disclosed technology is depicted in FIGS. 10-18. Embodiment 100 has generally flat, and relatively low, top platform 112. Platform 112 is formed by a set of width-wise slats, slightly spaced-apart in the length-wise direction. Upwardly-standing side rails 114 and 114′ form relatively low peripheral side edges of platform 12. Generally, side rails, 114 and 114′ extend up above platform 112 about ½-1½ inches, or in certain embodiments about ½-2½ inches. Platform 112's front end is relatively higher, comprising side buttresses 116 and 116′, and end board 118. End board 118 extends up above platform 112 about 3-6 inches. This way, when platform 112 is loaded, and masons' cart 100 is picked up by the user to move it, the load is not pitched off the front of the cart.

Embodiment 100 has two wheels 120 and 120′, the wheels 120 and 120′ being mounted on an axle 122 which passes through the lateral front sides of two, long handles 124 and 124′. Handles 124 and 124′ extend from near the back to near the front of cart 100. Handles 124 and 124′ are secured beneath wheel struts 126 and 126′ (strut 126 being barely visible in FIG. 1) by long bolts 28. This way, handles 124 and 124′ are secured to struts 126 and 126′, respectively, and also to platform 112, resulting in a rigid and strong combination thereof.

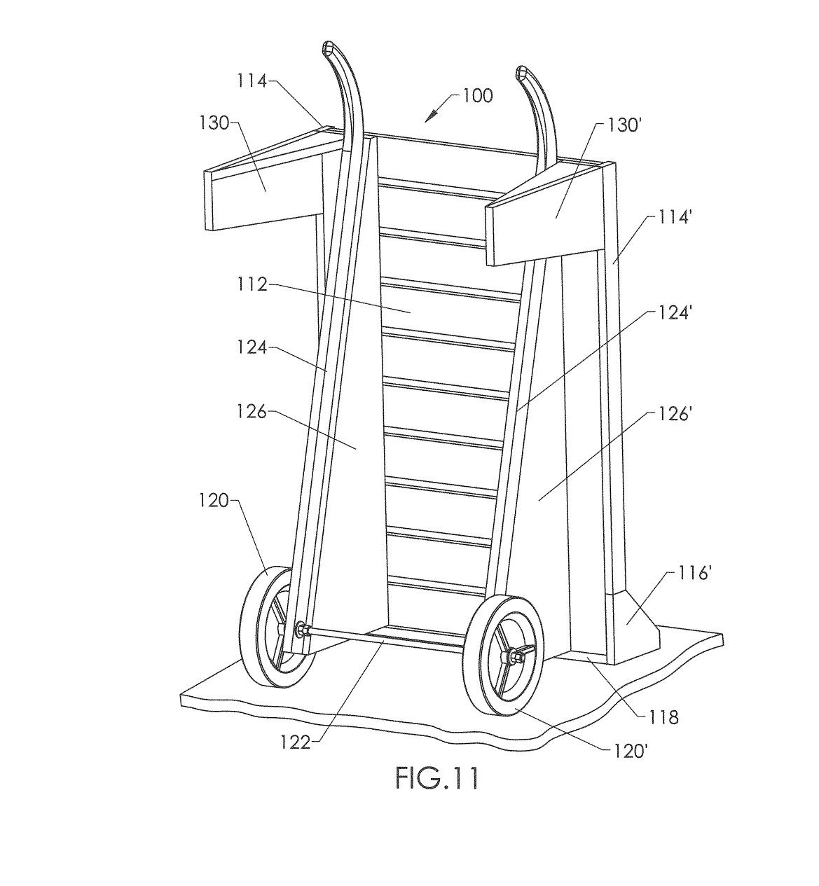

Also, masons' cart 100 has two rear legs 130 and 130′, extending downwardly from the bottom of platform 112, to support the back end of the cart when it is at rest. Synergistically, when constructed as shown, the horizontal plane for the center of gravity of cart 100 is between the bottom of platform 112 and axle 122. The way, when the cart 100 is tipped up all the way to rest on the front surface of end board 118, the cart will conveniently rest in this orientation for storage with less footprint as depicted in FIG. 11.

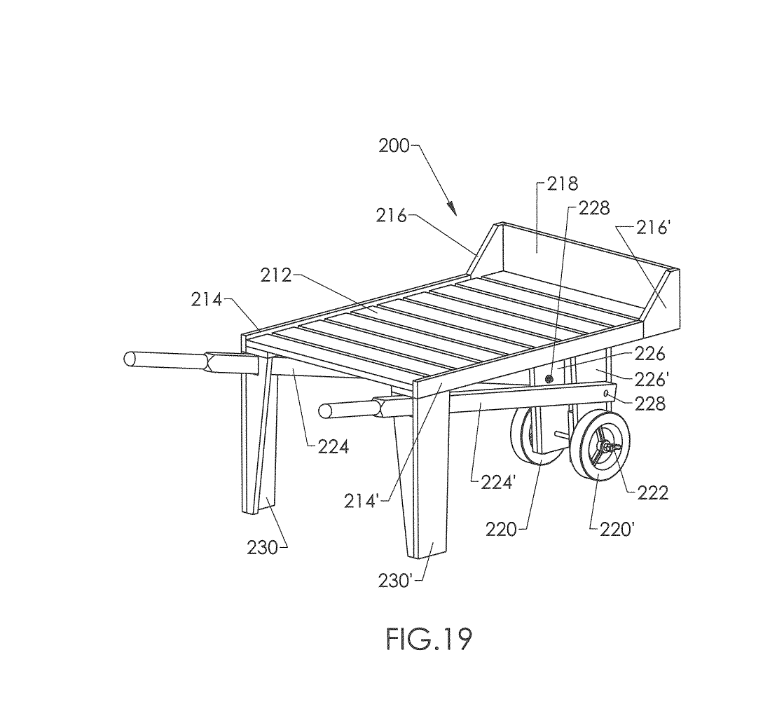

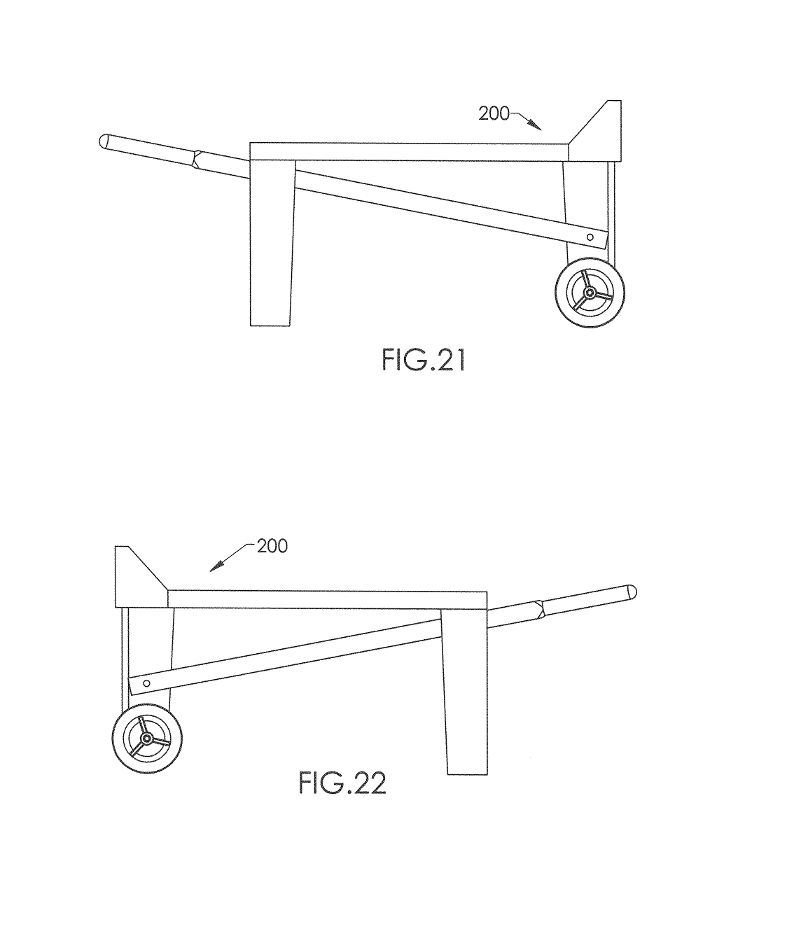

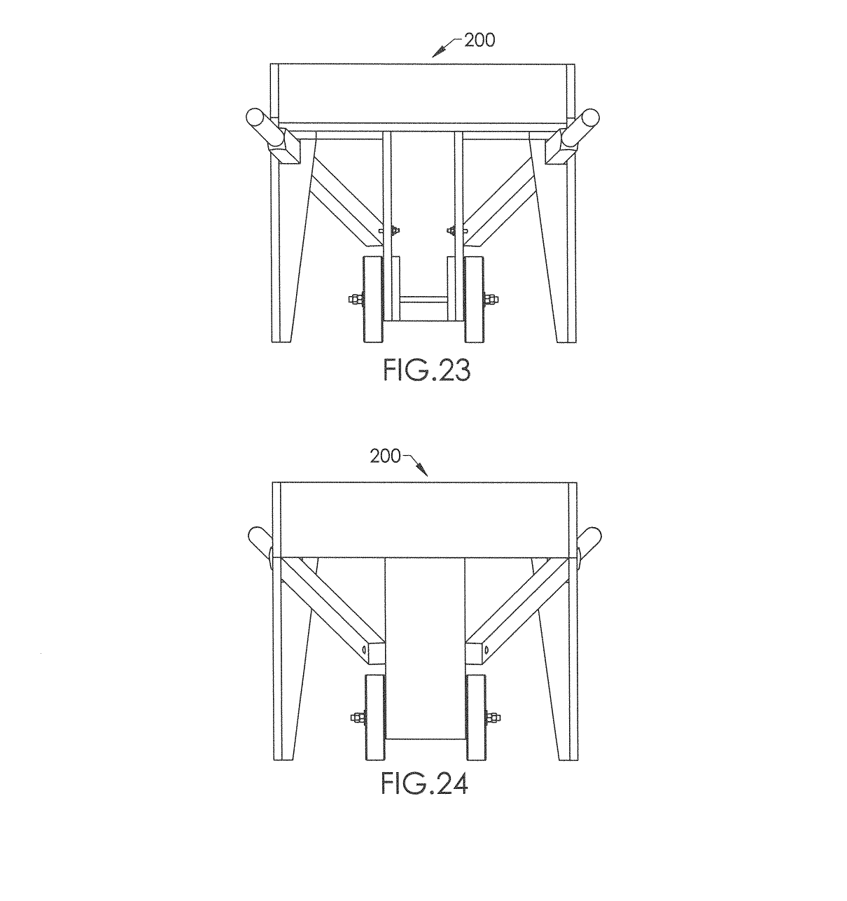

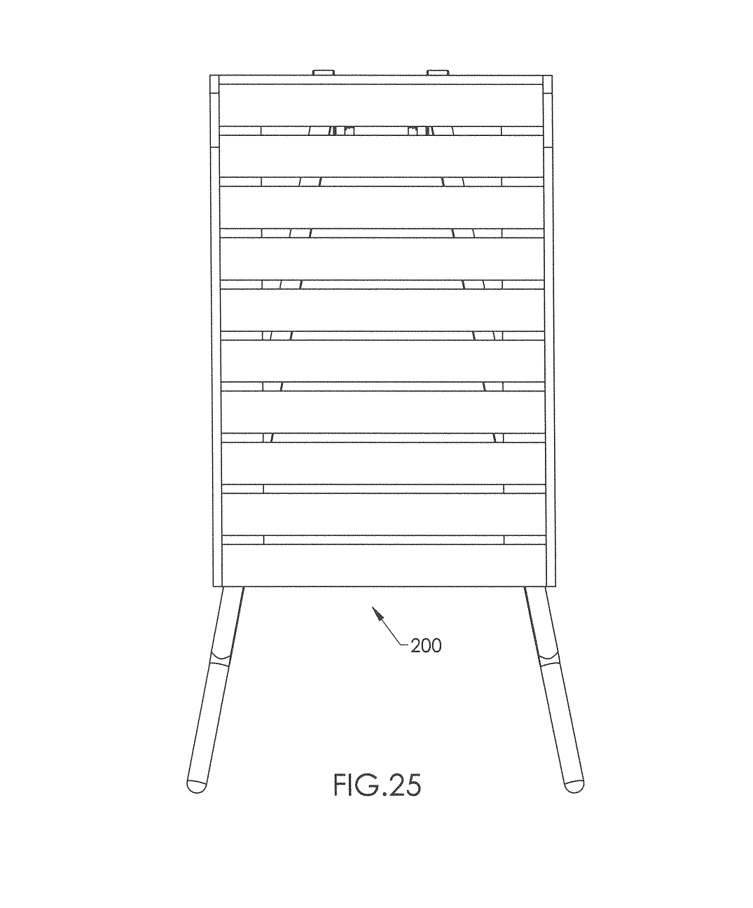

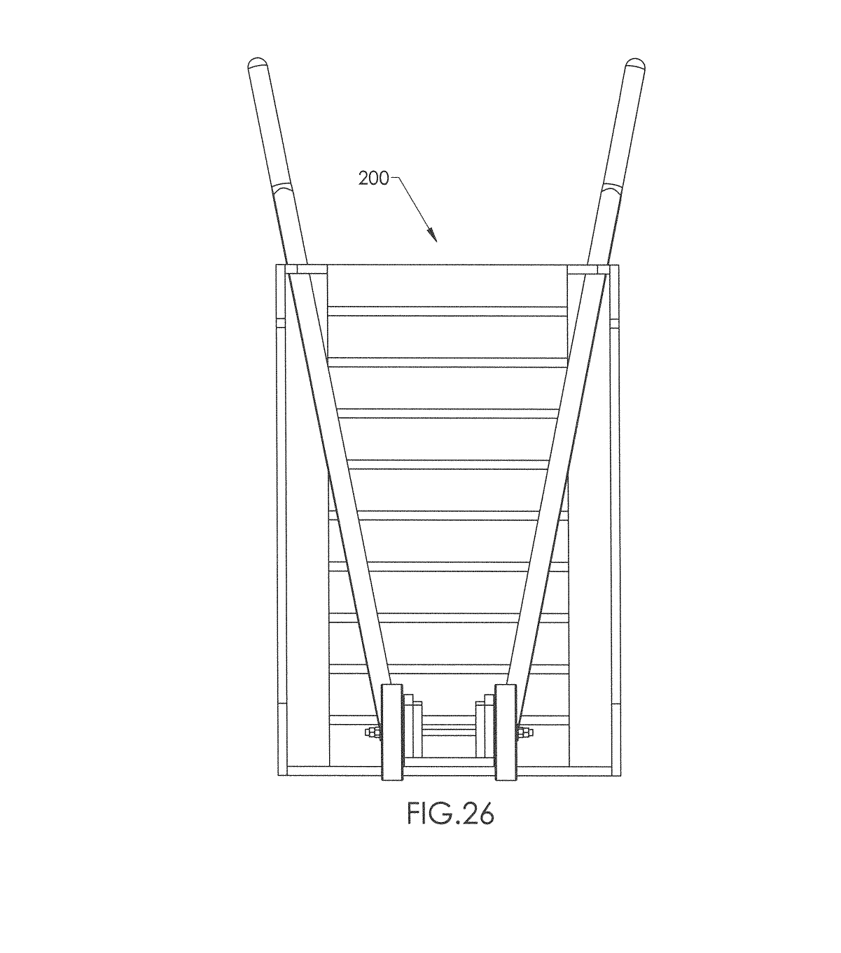

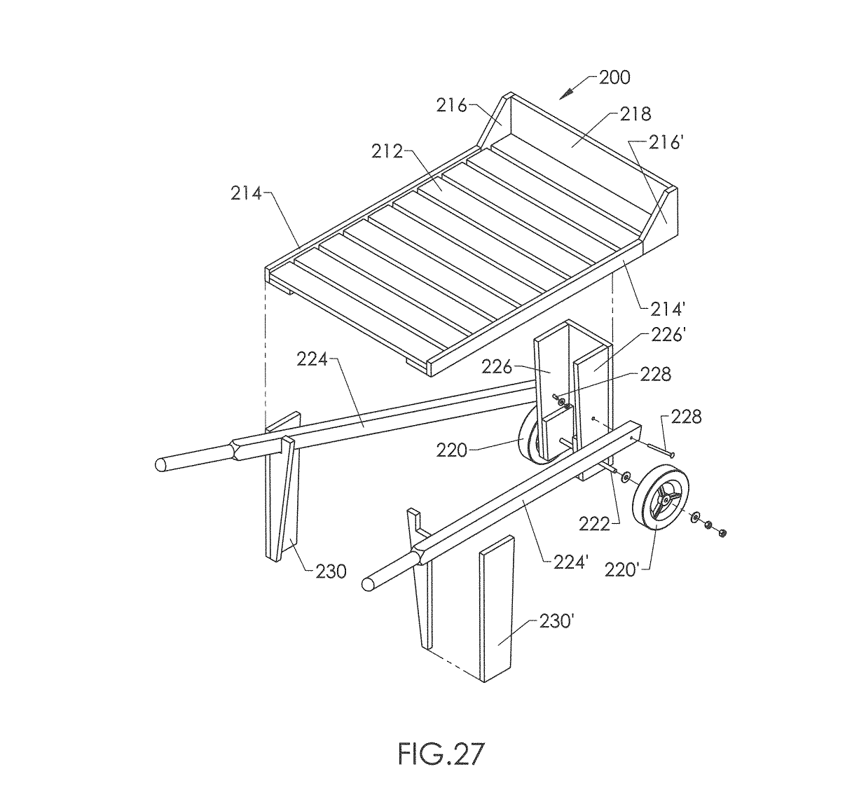

Embodiment 200 of the subject disclosed technology is depicted in FIGS. 19-27. Embodiment 200 has generally flat, and relatively low, top platform 212. Platform 212 is formed by a set of width-wise slats, slightly spaced-apart in the length-wise direction. Upwardly-standing side rails 214 and 214′ form relatively low peripheral side edges of platform 212. Generally, side rails, 214 and 214′ extend up above platform 212 about ½-1½ inches, or in certain embodiments about ½-2½ inches. Platform 212's front end is relatively higher, comprising side buttresses 216 and 216′, and end board 218. End board 218 extends up above platform 212 about 3-6 inches. This way, when platform 212 is loaded, and masons' cart 200 is picked up by the user to move it, the load is not pitched off the front of the cart.

Embodiment 200 has two wheels 220 and 220′, the wheels 220 and 220′ being mounted on an axle 222 which passes through the lateral sides of wheel struts 226 and 226′. Handles 224 and 224′ extend from near the back to near the front of cart 200. Handles 224 and 224′, respectively, are secured to the lateral sides of struts 226 and 226′ by long bolts 228. Also, handles 224 and 224′ are secured to the bottom of platform 212, and to inside of rear legs 230 and 230′, resulting in a rigid and strong combination thereof.

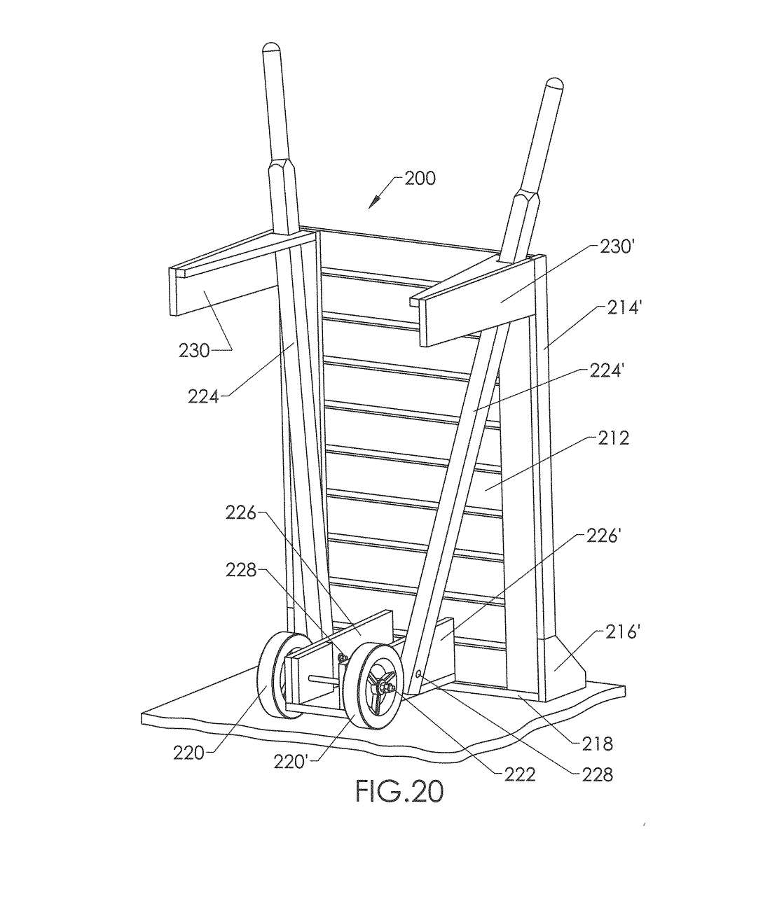

Also, masons' cart 200 has two rear legs 230 and 230′, extending downwardly from the bottom of platform 212, to support the back end of the cart when it is at rest. Synergistically, when constructed as shown, the horizontal plane for the center of gravity of cart 100 is between the bottom of platform 212 and axle 222. The way, when the cart 200 is tipped up all the way to rest on the front surface of end board 218, the cart will conveniently rest in this orientation for storage with less footprint as depicted in FIG. 20.

For example, as will be apparent from this description and the figures, certain embodiments may be described as: A masons' cart comprising: a generally flat, top platform; said platform having two lateral side edges extending up above the platform between about ½-2½; a wheel connected to a wheel strut extending downwardly from near the front end of the cart; a leg connected to and extending downwardly from near the back end of the cart; and a handle extending from near the back end of the cart to near the front end of the cart, the handle being secured to both the top platform is and the wheel strut. Certain of these carts have/comprise two wheels. Certain of the carts with two wheels have/comprise comprising two wheel struts. Certain of the carts described in the first sentence of this paragraph have/comprise comprising two legs. Certain of the carts described in the first sentence of this paragraph have/comprise two handles. Other embodiments will be apparent to those of skill in the art after reviewing this disclosure.

Although this disclosed technology has been described above with reference to particular means, materials, and embodiments, it is to be understood that the disclosed technology is not limited to these disclosed particulars, but extends instead to all equivalents within the scope of the following claims.

I claim:

1. A masons' cart comprising:
a generally flat, top platform;
said platform having two lateral side edges extending up above the platform;
a wheel connected to a wheel strut extending downwardly from near the front end of the cart;
a leg connected to and extending downwardly from near the back end of the cart; and
a handle extending from near the back end of the cart to near the front end of the cart, the handle being secured to both the top platform and the wheel strut.

2. The cart of claim 1 comprising two wheels.

3. The cart of claim 2 comprising two wheel struts.

4. The cart of claim 1 comprising two legs.

5. The cart of claim 1 comprising two handles.

6. The cart of claim 1 wherein the lateral side edges extend up above the platform between about ½-2½ inches.
